(19) United States
(12) Patent Application Publication
(10) Pub. No.: US 2020/0251716 A1
(43) Pub. Date: Aug. 6, 2020

(54) POSITIVE ELECTRODE FOR SECONDARY BATTERY, SECONDARY BATTERY, AND METHOD FOR PRODUCING POSITIVE ELECTRODE FOR SECONDARY BATTERY

(71) Applicant: PANASONIC INTELLECTUAL PROPERTY MANAGEMENT CO., LTD., Osaka-shi, Osaka (JP)

(72) Inventors: Hiroshi Kawada, Hyogo (JP); Atsushi Fukui, Hyogo (JP)

(73) Assignee: PANASONIC INTELLECTUAL PROPERTY MANAGEMENT CO., LTD., Osaka-shi, Osaka (JP)

(21) Appl. No.: 16/640,239

(22) PCT Filed: Jul. 2, 2018
(86) PCT No.: PCT/JP2018/024995

§ 371 Date: Feb. 19, 2020

(30) Foreign Application Priority Data
Sep. 25, 2017 (JP) 2017-184131

(51) Int. Cl. H01M 4/131; H01M 4/525; H01M 4/505; H01M 4/66; H01M 4/134; H01M 4/62; H01M 10/0525

(52) U.S. Cl. CPC H01M 4/131; H01M 4/525; H01M 4/505; H01M 2004/028; H01M 4/134; H01M 4/621; H01M 10/0525; H01M 4/667

(57) ABSTRACT

A positive electrode current collector, a positive electrode active material layer disposed on a surface of the positive electrode current collector, and a first film having lithium-ion permeability are included. The first film contains a lithium-ion permeable oxide X represented by LiₓM¹O_{y} (0.5≤x<4, 1≤y<6) and a fluorine-containing compound Y, covers at least part of a surface of the positive electrode active material layer, and partially covers the surface of the positive electrode current collector. The compound Y contains a bond between a metal element M² and a fluorine element, M¹ is at least one selected from the group consisting of B, Al, Si, P, S, Ti, V, Zr, Nb, Ta, and La, and M² is at least one selected from the group consisting of Li, Na, Al, Mg, and Ca.

### TECHNICAL FIELD

The present invention relates to an improvement in a positive electrode for a secondary battery.

### BACKGROUND ART

Nonaqueous electrolytes each containing a nonaqueous solvent and a lithium salt react partially and irreversibly with surfaces of positive and negative electrode active materials of nonaqueous-electrolyte secondary batteries typified by lithium-ion batteries in association with charging and discharging. Regarding the suppression of a side reaction on the positive electrode side, PTL 1 discloses a method for coating a positive electrode with a lithium ion-conducting glass by a sol-gel method.

### CITATION LIST

### Patent Literature

PTL 1: Japanese Published Unexamined Patent Application No. 2003-173770

### SUMMARY OF INVENTION

In recent years, secondary batteries have been required to maintain desired battery characteristics by suppressing side reactions and to improve safety in case of a short circuit without degrading desired battery characteristics. Thus, it is a main object of the present disclosure to provide a positive electrode for providing a secondary battery having improved battery safety without degrading desired battery characteristics.

One aspect of the present disclosure relates to a positive electrode for a secondary battery including a positive electrode current collector, a positive electrode active material layer disposed on a surface of the positive electrode current collector, and a first film having lithium-ion permeability,

in which the first film contains a lithium-ion permeable oxide X represented by LiₓM¹O_{y} (0.5≤x<4, 1≤y<6) and a fluorine-containing compound Y, covers at least part of a surface of the positive electrode active material layer, and partially covers the surface of the positive electrode current collector,

the compound Y contains a bond between a metal element M² and a fluorine element, M¹ is at least one selected from the group consisting of B, Al, Si, P, S, Ti, V, Zr, Nb, Ta, and La, and M² is at least one selected from the group consisting of Li, Na, Al, Mg, and Ca.

Another aspect of the present disclosure relates to a secondary battery including the positive electrode, a negative electrode, and a lithium ion-conducting electrolyte.

Yet another aspect of the present disclosure relates to a method for producing a positive electrode for a secondary battery, the method including the steps of: providing a positive electrode precursor including a positive electrode current collector and a positive electrode active material layer disposed on a surface of the positive electrode current collector; and covering at least part of a surface of the positive electrode active material layer with a first film having lithium-ion permeability and partially covering the surface of the positive electrode current collector,

in which the first film is formed by exposing the positive electrode precursor to an atmosphere that contains a raw material of the first film and that has a temperature of 200° C. or lower.

According to the positive electrode for a secondary battery of the present disclosure, battery safety can be improved without degrading desired battery characteristics.

### BRIEF DESCRIPTION OF DRAWINGS

FIG. 1 is a partially cutaway perspective view of a secondary battery according to an embodiment of the present invention.

### DESCRIPTION OF EMBODIMENTS

A positive electrode for a secondary battery according to an embodiment of the present invention includes a positive electrode current collector, a positive electrode active material layer disposed on a surface of the positive electrode current collector, and a first film having lithium-ion permeability. The first film contains a lithium-ion permeable oxide X represented by LiₓM¹O_{y} (0.5≤x<4, 1≤y<6) and a fluorine-containing compound Y. The first film covers at least part of a surface of the positive electrode active material layer and partially convers a surface of the positive electrode current collector. The compound Y contains a bond between a metal element M² and a fluorine element. M¹ is at least one selected from the group consisting of B, Al, Si, P, S, Ti, V, Zr, Nb, Ta, and La. M² is at least one selected from the group consisting of Li, Na, Al, Mg, and Ca.

A site of the surface of the positive electrode active material layer acting as a starting point for the decomposition of an electrolyte can be covered by uniformly covering the surface of the positive electrode active material layer with the oxide X having lithium-ion permeability and the fluorine-containing compound Y. This enables the suppression of a side reaction, improving battery safety without degrading the battery characteristics.

The surface of the positive electrode active material layer is not limited to the surface of the positive electrode active material layer opposite a negative electrode with a separator provided therebetween. The surface of the positive electrode active material layer also includes inner walls of voids in the porous positive electrode active material layer. Preferably, the first film covering the surface of the positive electrode active material layer extends to the insides of the voids in the positive electrode active material layer and covers the inner walls.

In the case where the first film is formed after the formation of the positive electrode active material layer, the first film can partially cover the surface of the positive electrode current collector. The surface of the positive electrode current collector is not completely covered with a positive electrode active material and a binder but has a small exposed surface portion when viewed microscopically. A cut end face and a lead-wire attachment portion of the positive electrode current collector are exposed, in some cases. The decomposition of the electrolyte starting from the surface of the positive electrode current collector is also suppressed by covering such an exposed surface portion with the first film.

In the case where the positive electrode active material layer is composed of a mixture (material mixture) containing, for example, a positive electrode active material and a binder (binding agent), after the positive electrode active material particles and the binder are mixed together and then the positive electrode active material layer is formed, the first film that covers the surface of the positive electrode active material layer is formed on the surface of the positive electrode active material layer. Thus, unlike the case where the first film is formed on each of the positive electrode active material particles in advance, there can be a region where the first film is not present at an adhesion interface between the positive electrode active material particles and the binder. Similarly, there can be a region where the first film is not present at a contact interface between the positive electrode active material particles and the positive electrode current collector. Furthermore, there can be a region where the first film is not present at a contact interface between the positive electrode active material particles adjacent to each other.

When the first film is formed after the formation of the positive electrode active material layer, the first film can partially cover the surface of the binder. When the positive electrode active material layer contains a conductive agent, the first film can partially cover the surface of the conductive agent. This also suppresses the decomposition of the electrolyte starting from the binder or the conductive agent.

To cover the surface of the binder with the first film, the first film needs to be formed at a temperature lower than the heatproof temperature of the binder. The heatproof temperature of the binder varies depending on the type of binder. As a guide, the temperature at which the first film is formed is preferably 200° C. or lower, more preferably 120° C. or lower.

The first film contains the oxide X having lithium-ion permeability and the fluorine-containing compound Y. The incorporation of the fluorine-containing compound Y enables the formation of a chemically stable coating film. The element M¹ contained in the oxide X is preferably at least one selected from the group consisting of B, Al, Si, P, S, Ti, V, Zr, Nb, Ta, and La. At least one selected from the group consisting of P, Si, and B is more preferred because of the inexpensiveness of a raw material. The element M¹ even more preferably contains at least P.

The compound Y is not particularly limited as long as it contains a bond between the metal element M² and a fluorine element. M² is preferably at least one selected from the group consisting of Li, Na, Al, Mg, and Ca. Among these, it is more preferred that M² contain Li and the compound Y contain LiF.

The oxide X represented by the composition formula LiₓM¹O_{y} contains an ionic O—Li bond. The lithium-ion permeability is developed by the hopping of lithium ions through O-sites. The oxide X is preferably a polyoxymetalate compound in view of stability. Preferably, the ranges of x and y are, for example, 0.5≤x<4, and 1≤y<6.

As the polyoxymetalate compound, for example, Li₃PO₄, Li₄SiO₄, Li₂Si₂O₅, Li₂SiO₃, Li₃BO₃, Li₃VO₄, Li₃NbO₄, LiZr₂ (PO₄) LiTaO₃, Li₄Ti₅O₂, Li₇La₃Zr₂O₁₂, Li₅La₃Ta₂O₁₂, Li_{0.35}La_{0.55}TiO₃, Li₉SiAlO₈, and Li_{1.3}Al_{0.3}Ti_{1.7}(PO₄)₃ may be used alone or in any combination. The composition of the oxide X more preferably contains at least Li₃PO₄, also preferably 80% or more and 95% or less Li₃PO₄ and 5% or more and 20% or less lithium silicate on a mass ratio basis. Examples of lithium silicate include Li₄SiO₄, Li₂Si₂O₅, and Li₂SiO₃. The incorporation of lithium silicate in the oxide X can improve the denseness of the first film.

In these polyoxymetalate compounds, the composition ratios of lithium to oxygen need not match stoichiometric compositions. Rather, when the composition ratio of oxygen in the oxide X is smaller than the stoichiometric composition, lithium-ion permeability is easily developed by the presence of oxygen defects. Specifically, when the oxide X is lithium phosphate, LiₓPO_{y} (1≤x<3, 3≤y<4) is more preferred. When the oxide X is lithium silicate, LiₓSiO_{y} (2≤x<4, 3≤y<4) is more preferred.

The first film can be formed by, for example, an atomic layer deposition (ALD) method. In the ALD method, a source gas for the oxide X is fed into a reaction chamber to form a film composed of the oxide X, and a source gas for the compound Y is fed into the reaction chamber to form a film of the compound Y. At this time, the simultaneous feeding of the source gas for the oxide X and the source gas for the compound Y into the reaction chamber enables the formation of the first film in which both of the oxide X and the compound Y are present in the same atomic layer. Alternatively, the source gas for the oxide X and the source gas for the compound Y may be sequentially fed into the reaction chamber to form a film composed of the compound Y on the film composed of the oxide X, thereby forming the first film. When the first film has a thickness of about 0.5 nm or more, the effect of suppressing a side reaction can be provided.

In the case of forming the film of the oxide X by the ALD method, the first film can contain a nitrogen atom because a lithium-ion source contains a nitrogen atom. The first film has higher conductivity by the incorporation of nitrogen into the oxide X. Even if the first film has a larger thickness, the lithium-ion permeability can be maintained, so that the battery characteristics are less likely to deteriorate.

An example of a sheet-like positive electrode included in a wound electrode group or stacked electrode group will be further described below.

### (Positive Electrode)

The sheet-like positive electrode includes a sheet-like positive electrode current collector, a positive electrode active material layer disposed on a surface of the positive electrode current collector, and the first film disposed on a surface of the positive electrode active material layer. The positive electrode active material layer may be formed on one of the surfaces of the positive electrode current collector or both of the surfaces thereof.

### (Positive Electrode Current Collector)

Examples of the positive electrode current collector include metal foil and metal sheets. Examples of a material that can be used for the positive electrode current collector include stainless steel, aluminum, aluminum alloys, and titanium. The thickness of the positive electrode current collector can be selected from, for example, 3 to 50 m.

### (Positive Electrode Active Material Layer)

A description will be given below of the case where the positive electrode active material layer is a mixture (material mixture) containing positive electrode active material particles. The positive electrode active material layer contains a positive electrode active material and a binder as essential components and may contain a conductive agent as an optional component. The amount of the binder contained in the positive electrode active material layer is preferably 0.1 to 20 parts by mass, more preferably 1 to 5 parts by mass per 100 parts by mass of the positive electrode active material. The positive electrode active material layer has a thickness of, for example, 10 to 100 μm.

The positive electrode active material is preferably a lithium-containing transition metal oxide. Examples of a transition metal element include Sc, Y, Mn, Fe, Co, Ni, Cu, and Cr. Among these, for example, Mn, Co, and Ni are preferred. The lithium-containing transition metal oxide is more preferably a lithium-nickel complex oxide containing Li, Ni, and another metal.

Examples of the lithium-nickel complex oxide include LiₐNi_{b}M³_{1-b}O₂ (where M³ is at least one selected from the group consisting of Mn, Co, and Al, 0<a≤1.2, and 0.3≤b≤1). From the viewpoint of increasing the capacity, it is preferable to satisfy 0.85≤b≤1. In view of the stability of the crystal structure, LiₐNi_{b}CO_{c}Al_{d}O₂ containing Co and Al as M³ (0<a≤1.2, 0.85≤b<1, 0<c<0.15, 0<d≤0.1, and b+c+d=1) is more preferred.

Specific examples of the lithium-nickel complex oxide include lithium-nickel-cobalt-manganese complex oxides (such as LiNi_{0.5}Co_{0.2}Mn_{0.3}O₂, LiNi_{1/3}Co_{1/3}Mn_{1/3}O₂, and LiNi_{0.4}Co_{0.2}Mn_{0.4}O₂), lithium-nickel-manganese complex oxides (such as LiNi_{0.5}Mn_{0.5}O₂), lithium-nickel-cobalt complex oxides (such as LiNi_{0.8}Co_{0.2}O₂), and lithium-nickel-cobalt-aluminum complex oxides (such as LiNi_{0.8}Co_{0.15}Al_{0.05}O₂, LiNi_{0.8}Co_{0.18}Al_{0.02}O₂, and LiNi_{0.88}Co_{0.09}Al_{0.03}O₂).

From the viewpoint of enhancing the filling properties of the positive electrode active material into the positive electrode active material layer, it is desirable that the average particle size (D50) of the positive electrode active material particles be sufficiently small with respect to the thickness of the positive electrode active material layer. The positive electrode active material particles preferably have an average particle size (D50) of, for example, 5 to 30 m, more preferably 10 to 25 m. The average particle size (D50) refers to a median diameter at 50% cumulative volume in a volume-based particle size distribution. The average particle size is measured with, for example, a laser diffraction/scattering particle size distribution analyzer.

Examples of the binder (binding agent) include fluorocarbon resins, such as poly(vinylidene fluoride) (PVdF), polytetrafluoroethylene (PTFE), and tetrafluoroethylene-hexafluoropropylene copolymers (HFP); acrylic resins, such as poly(methyl acrylate) and ethylene-methyl methacrylate copolymers; rubber-like materials, such as styrene-butadiene rubber (SBR) and acrylic rubber; and water-soluble polymers, such as carboxymethyl cellulose (CMC) and polyvinylpyrrolidone.

As the conductive agent, carbon black, such as acetylene black or Ketjenblack, is preferred.

The positive electrode active material layer can be formed by mixing the positive electrode active material particles, the binder, and so forth together with a dispersion medium to prepare a positive electrode slurry, applying the positive electrode slurry to a surface of the positive electrode current collector, performing drying, and performing rolling. Examples of the dispersion medium that can be used include water; alcohol, such as ethanol; ethers, such as tetrahydrofuran; and N-methyl-2-pyrrolidone (NMP). In the case where water is used as the dispersion medium, the rubber-like material and the water-soluble polymer are preferably used together as the binder.

### (First Film Having Lithium-Ion Permeability)

The first film is desirably a uniform layer that covers the surface of the positive electrode active material layer in a necessary and sufficient amount. The thickness of the first film is desirably smaller than the average particle size of the positive electrode active material, for example, preferably 0.1 m (100 nm) or less, more preferably 0.03 m (30 nm) or less. However, if the first film has an insufficiently small thickness, for example, the transfer of carriers (electrons or holes) by the tunnel effect can proceed to cause the proceeding of the oxidative decomposition of the electrolyte. From the viewpoints of suppressing the carrier transfer and smoothly transferring lithium ions, the first film preferably has a thickness of 0.5 nm or more.

The first film is formed after the formation of the positive electrode active material layer. Thus, a region where the first film is not formed can be present at, for example, the contact interface between the positive electrode active material particles, or the adhesion interface between the positive electrode active material particles and the binder.

The first film may be composed of any material having a lithium-ion conductivity of, for example, 1.0×10⁻¹¹ S/cm or more. From the viewpoint of minimizing the oxidative decomposition of the electrolyte, the first film desirably has low conductivity, desirably a conductivity of less than 1.0×10⁻² S/cm.

From the viewpoint of ensuring the capacity of the positive electrode, the proportion of the first film in the positive electrode is desirably minimized. The amount of the first film contained in the positive electrode is preferably 0.01 to 10 parts by mass, more preferably 0.05 to 5 parts by mass per 100 parts by mass of the positive electrode active material layer.

A method for producing a positive electrode for a secondary battery according to an embodiment of the present disclosure includes the steps of: (i) providing a positive electrode precursor including a positive electrode current collector and a positive electrode active material layer disposed on a surface of the positive electrode current collector; and (ii) covering at least part of a surface of the positive electrode active material layer with a first film having lithium-ion permeability and partially covering the surface of the positive electrode current collector.

In the step (ii), the first film is formed by exposing the positive electrode precursor to an atmosphere containing a raw material of the first film. At this time, the atmosphere containing the raw material of the first film preferably has a temperature of 200° C. or lower, more preferably 120° C. or lower. The first film is preferably formed by a liquid-phase method or a gas-phase method.

Preferred examples of the liquid-phase method include precipitation methods and sol-gel methods. A precipitation method refers to, for example, a method in which the positive electrode precursor is immersed in a solution containing a raw material of the first film dissolved therein and having a temperature sufficiently lower than 200° C. to precipitate a constituent material of the first film on surfaces of the positive electrode active material layer and the positive electrode current collector. A sol-gel method refers to, for example, a method in which a positive electrode precursor is immersed in a liquid containing a raw material of the first film and having a temperature sufficiently lower than 200° C., and then intermediate particles of the first film are deposited on surfaces of the positive electrode active material layer and the positive electrode current collector and subjected to gelation.

Examples of the gas-phase method include physical vapor deposition (PVD) methods, chemical vapor deposition (CVD) methods, and atomic layer deposition (ALD) methods. The PVD method and the CVD methods are usually performed at a high temperature of higher than 200° C. In the case of the ALD method, the first film can be formed with an atmosphere containing a raw material of the first film and having a temperature of 200° C. or lower, even 120° C. or lower.

In the ALD method, an organic compound having a high vapor pressure is used as a raw material of the first film. The vaporization of the raw material enables the molecular raw material to interact with surfaces of the positive electrode active material layer and the positive electrode current collector. The molecular raw material can easily reach voids in the positive electrode active material layer, so that the first film is also formed on inner walls of the voids easily and uniformly.

In the ALD method, for example, the first film that covers the positive electrode active material layer and the positive electrode current collector is formed by the following procedure.

In the case where the film of the oxide X is formed by the ALD method, a gaseous first raw material is first introduced into a reaction chamber in which the positive electrode precursor is placed. After that, when the surface of the positive electrode precursor is covered with the monomolecular layer of the first raw material, a self-termination mechanism by the organic group of the first raw material works. Then the first raw material is not adsorbed on the surface of the positive electrode precursor any longer. An excess of the first raw material is removed from the reaction chamber by purging with, for example, an inert gas.

Next, a gaseous second raw material is introduced into the reaction chamber in which the positive electrode precursor is placed. When the reaction between the monomolecular layer of the first raw material and the second raw material is completed, the second raw material is not adsorbed on the surface of the positive electrode precursor any longer. An excess of the second raw material is removed from the reaction chamber by purging with, for example, an inert gas.

As described above, a series of operations including the introduction of the first raw material, purging, the introduction of the second raw material, and purging is repeated a predetermined number of times, thereby forming the film of lithium oxide X containing the element M¹ and lithium.

The materials used as the first raw material and the second raw material are not particularly limited. Appropriate compounds may be selected according to the desired oxide X. Examples of the first raw material include materials containing phosphorus as the element M¹ (such as trimethyl phosphate, triethyl phosphate, tris(dimethylamino)phosphine, and trimethylphosphine); materials containing silicon as the element M¹ (such as tetramethyl orthosilicate and tetraethyl orthosilicate); materials containing both the element M¹ and lithium (such as lithium (bistrimethylsilyl)amide); and materials serving as sources of lithium (such as lithium tert-butoxide and cyclopentadienyllithium).

When a material containing the element M¹ is used as the first raw material, a material serving as a source of lithium (or a material containing both of the element M¹ and lithium) is used as the second raw material. When a material serving as a source of lithium is used as the first raw material, a material containing the element M¹ (or a material containing both of the element M¹ and lithium) is used as the second raw material. When a material containing both of the element M¹ and lithium is used as the first raw material, an oxidant (for example, oxygen or ozone) may be used as the second raw material.

In the case where the film of the fluorine-containing compound Y is formed by the ALD method after the formation of the film of the oxide X, the same process as in the formation of the film of the oxide X may be performed, except that the first raw material and the second raw material are changed. The materials used as the first raw material and the second raw material are not particularly limited. Appropriate compounds may be selected according to the desired compound Y. For example, when lithium is contained as the metal element M², the foregoing material can be used. Examples of sources of other metal elements M² (sodium, aluminum, potassium, magnesium, and calcium) include tert-butoxides of these metal elements.

Examples of a material serving as a fluorine source include fluorine gas, HF gas, and NH₄F. An example of a material containing both of the metal element M² and fluorine is LiF.

The first film can be formed by sequentially forming the film of the oxide X and the film of the compound Y. The first film may have a two-layer structure in which the film of the compound Y is disposed on the film of the oxide X, or may be a multilayer film in which films of the oxide X and films of the compound Y are alternately deposited.

Regarding the first raw material and the second raw material, a source gas to form the film of the oxide X and a source gas to form the film of the compound Y may be simultaneously supplied to a reaction chamber to simultaneously form the film of the oxide X and the film of the compound Y. In this case, both of the oxide X and the compound Y are present in the same atomic layer on the surface of the first film. In this case, a film having high chemical stability is formed owing to the compound Y on the surface of the first film, thus providing the effect of highly suppressing a side reaction. Furthermore, lithium ions can permeate through the oxide X present on the surface of the first film to the positive electrode active material (from the positive electrode active material) without hindering the permeation of lithium ions due to the compound Y on the surface of the first film.

In each of the film formation of the oxide X and the film formation of the compound Y, an oxidant may be introduced into the reaction chamber at a freely-selected timing and used in combination with another raw material in order to promote the reaction of each raw material. The introduction of the oxidant may be performed at a freely-selected timing or every cycle in the repetition of the series of operations.

Three or more types of raw materials may also be used. That is, one or more types of raw materials may also be used in addition to the first raw material and the second raw material. For example, a series of operations including the introduction of the first raw material, purging, the introduction of the second raw material, purging, the introduction of a third raw material different from the first raw material or the second raw material, and purging may be repeated.

In the case where the binder contains a fluorine compound such as poly(vinylidene fluoride) (PVdF), part of the fluorine compound in the binder may be sublimed in the reaction chamber. The sublimed fluorine compound works as a fluorine source in the ALD method. Thus, in the case of using a fluorine compound as a binder, only materials needed to form the film of the oxide X may be selected as the first raw material and the second raw material. As a result of the supply of fluorine from the binder, the first film in which both of the oxide X and the compound Y having a lithium-fluorine bond (LiF) are present in the same atomic layer can be formed.

The film formation of the oxide X and the compound Y is preferably performed by the same method or may be performed by different methods. For example, the film formation of one of the oxide X and the compound Y may be performed by a liquid-phase method, and the other may be performed by a gas-phase method.

Components other than a positive electrode will be described in detail below by taking a prismatic wound battery as an example. However, the type, shape, and so forth of the secondary battery are not particularly limited.

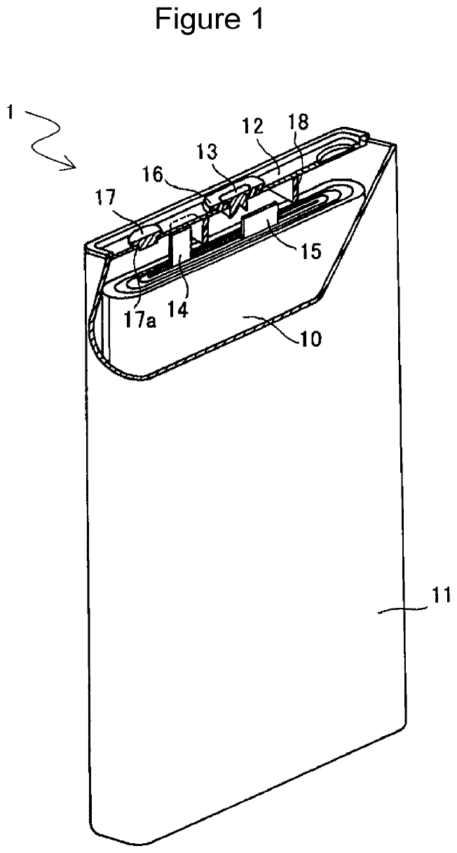

FIG. 1 is a schematic perspective view illustrating a prismatic secondary battery according to an embodiment of the present invention. In FIG. 1, a part thereof is cut away to illustrate the configuration of the main portion of a secondary battery 1. A prismatic battery case 11 accommodates a flat wound electrode group 10 and an electrolyte (not illustrated).

A positive electrode current collector of a positive electrode contained in the electrode group 10 is connected to one end portion of a positive electrode lead 14. The other end portion of the positive electrode lead 14 is connected to a sealing plate 12 functioning as a positive electrode terminal. A negative electrode current collector is connected to one end portion of a negative electrode lead 15. The other end portion of the negative electrode lead 15 is connected to a negative electrode terminal 13 disposed in the middle of the sealing plate 12. A gasket 16 is disposed between the sealing plate 12 and the negative electrode terminal 13 to insulate them from each other. A frame body 18 composed of an insulating material is disposed between the sealing plate 12 and the electrode group 10 to insulate the negative electrode lead 15 from the sealing plate 12. The sealing plate 12 is joined to the open end of the prismatic battery case 11 to seal the prismatic battery case 11. The sealing plate 12 has an inlet 17a. The electrolyte is injected into the prismatic battery case 11 through the inlet 17a. Then the inlet 17a is plugged with a sealing plug 17.

### (Negative Electrode)

A sheet-like negative electrode includes a sheet-like negative electrode current collector and a negative electrode active material layer disposed on a surface of the negative electrode current collector. The negative electrode active material layer may be formed on one of the surfaces of the negative electrode current collector or both of the surfaces thereof.

### (Negative Electrode Current Collector)

Examples of the negative electrode current collector include metal foil, metal sheets, mesh bodies, punching sheets, and expanded metals. Examples of a material that can be used for the negative electrode current collector include stainless steel, nickel, copper, and copper alloys. The thickness of the negative electrode current collector may be selected from a range of, for example, 3 to 50 μm.

### (Negative Electrode Active Material Layer)

The negative electrode active material layer can be formed by a method similar to the production of the positive electrode active material layer using a negative electrode slurry containing a negative electrode active material, a binder (binding agent), and a dispersion medium. The negative electrode active material layer may contain an optional component such as a conductive agent, as needed. The amount of the binder contained in the negative electrode active material layer is preferably 0.1 to 20 parts by mass, more preferably 1 to 5 parts by mass per 100 parts by mass of the negative electrode active material. The negative electrode active material layer has a thickness of, for example, 10 to 100 μm.

The negative electrode active material may be a non-carbon material, a carbon material, or a combination thereof. A carbon material usually occludes or releases lithium ions at a potential of 1 V or less with respect to metal lithium. In this potential range, the reductive decomposition of electrolyte components proceeds easily on a surface of the carbon material, and a solid-electrolyte interface (SEI) is easily formed. However, as described below, by covering a surface of the negative electrode active material layer with a lithium-ion permeable second film, the contact between the carbon material and the electrolyte is suppressed to suppress the formation of SEI.

Examples of a carbon material used as the negative electrode active material include, but are not particularly limited to, at least one selected from the group consisting of graphite and hard carbon. In particular, graphite is promising because of its high capacity and low irreversible capacity. Additionally, graphite has high activity in the reductive decomposition of the electrolyte. Thus, the effect of covering the surface of the negative electrode active material layer with the second film is noticeable.

Graphite is a general term for carbon materials having a graphite structure and includes, for example, natural graphite, artificial graphite, expanded graphite, and graphitized mesophase carbon particles. Examples of natural graphite include flake graphite and amorphous graphite. Usually, a carbon material in which the interplanar spacing d₀₀₂, which is calculated from an X-ray diffraction spectrum, of the 002 plane of the graphite structure is 3.35 to 3.44 Å is classified as graphite. Hard carbon refers to a carbon material in which fine graphite crystals are arranged in random directions, substantially no further graphitization proceeds, and the interplanar spacing d₀₀₂ is larger than 3.44 Å.

The non-carbon material used as the negative electrode active material is preferably an alloy-based material. The alloy-based material preferably contains silicon or tin. In particular, elemental silicon and silicon compounds are preferred. Silicon compounds include silicon oxide and silicon alloys.

At least part of the surface of the negative electrode active material layer may be covered with the second film having lithium-ion permeability. For example, the second film is formed after the formation of the negative electrode active material layer. In this case, the second film can partially cover a surface of the negative electrode current collector in addition to the surface of the negative electrode active material layer.

Examples of a material contained in the second film include the same materials as the oxide X contained in the first film. That is, the second film can be a lithium-ion permeable oxide represented by the composition formula LiₓM¹O_{y} (0.5≤x<4, 1≤y<6) where M¹ is at least one selected from the group consisting of B, Al, Si, P, S, Ti, V, Zr, Nb, Ta, and La. The element M¹ in the oxide X contained in the second film may be the same as the element M¹ contained in the first film or may contain another element. Examples of a method for producing the second film include the same methods as those for the first film.

### (Separator)

As a separator, for example, a microporous film, a non-woven fabric, or a woven fabric composed of a resin is used. Examples of the resin used include polyolefins, such as polyethylene (PE) and polypropylene (PP), polyamide, and polyamide-imide.

### (Electrolyte)

The electrolyte contains a solvent and a solute dissolved in the solvent. Various lithium salts are used as the solute. The electrolyte has a lithium-salt concentration of, for example, 0.5 to 1.5 mol/L.

Examples of the solvent include nonaqueous solvents, for example, cyclic carbonates, such as propylene carbonate (PC) and ethylene carbonate (EC), chain carbonates, such as diethyl carbonate (DEC), ethyl methyl carbonate (EMC), and dimethyl carbonate (DMC), and cyclic carboxylates, such as γ-butyrolactone and γ-valerolactone; and water. These solvents may be used alone or in combination of two or more.

Examples of the lithium salt include LiPF₆, LiBF₄, LiClO₄, LiAsF₆, LiCF₃SO₃, LiN(SO₂F)₂, and LiN(SO₂CF₃)₂. These lithium salts may be used alone or in combination of two or more.

### EXAMPLES

The present invention will be specifically described below on the basis of examples and comparative examples. However, the present invention is not limited to these examples described below.

### Example 1

A secondary battery was produced according to the following procedure.

### (1) Production of Positive Electrode

A lithium-containing transition metal oxide (LiNi_{0.88}Co_{0.09}Al_{0.03}O₂(NCA)) serving as a positive electrode active material containing Li, Ni, Co, and Al, acetylene black (AB) serving as a conductive material, and poly(vinylidene fluoride) (PVdF) serving as a binder were mixed at a mass ratio of NCA:AB:PVdF=100:1:0.9. An appropriate amount of N-methyl-2-pyrrolidone (NMP) was added thereto. The mixture was stirred to prepare a positive electrode slurry. The resulting positive electrode slurry was applied to both surfaces of aluminum foil (positive electrode current collector) and dried. The coating films of the positive electrode material mixture were rolled with rollers to produce a positive electrode precursor.

The positive electrode precursor was placed in a predetermined reaction chamber. A lithium-ion permeable first film was formed on each surface of the positive electrode precursor.

(i) An element M¹ (phosphorus: P) and a first raw material (trimethyl phosphate) serving as an oxygen (O) source were vaporized and introduced into the reaction chamber in which the positive electrode precursor was placed. The temperature of an atmosphere containing the first raw material was controlled at 120° C., and the pressure thereof was controlled at 260 Pa. After 30 seconds, an excess of the first raw material was purged with nitrogen gas under the assumption that each surface of the positive electrode precursor was covered with the monomolecular layer of the first raw material.

(ii) Next, a second raw material (lithium (bistrimethylsilyl)amide serving as a lithium source was vaporized and introduced into the reaction chamber in which the positive electrode precursor was placed. The temperature of an atmosphere containing the second raw material was controlled at 120° C., and the pressure was controlled at 260 Pa. After 30 seconds, an excess of the second raw material was purged with nitrogen gas under the assumption that the monomolecular layer of the first raw material reacted with the second raw material.

(iii) A series of operations including the introduction of the first raw material, purging, the introduction of the second raw material, and purging was repeated 100 times to form first films containing an oxide X and a compound Y.

Analysis of the composition of the first films by XPS, ICP, and so forth revealed that lithium phosphate was formed.

Analysis of the XPS spectrum thereof revealed that the peak of a fluorine is spectrum originating from Li—F was observed at 685 eV (±1 eV). Additionally, the peak of a fluorine is spectrum originating from PVdF was observed at 688 eV (±2 eV). The results demonstrated that fluorine contained in the positive electrode precursor was present in a state of being bonded to lithium in the first films.

The mass of the first films with respect to the total mass of the positive electrode active material layers was determined from the mass of the positive electrode precursor before the formation of the first films, the mass of the positive electrode after the formation of the first films, the composition of the positive electrode active material layers, and the density of the materials and found to be 0.1 parts by mass per 100 parts by mass of the positive electrode active material layers.

The thickness of each first film is estimated to be in the range of 10 nm to 25 nm on the basis of the number of series of operations in the ALD.

The positive electrode precursor on which the first films were formed was cut into a predetermined electrode size to produce a positive electrode having a positive electrode material mixture layer on each surface of the positive electrode current collector.

### (2) Production of Negative Electrode

Natural graphite particles (average particle size (D50): 50 μm) serving as a negative electrode active material and a binder were mixed with an appropriate amount of water to prepare a negative electrode slurry. As the binder, SBR and CMC were used in combination. One part by mass of SBR and 1 part by mass of CMC were mixed per 100 parts by mass of the natural graphite particles. The resulting negative electrode slurry was applied to both surfaces of copper foil having a thickness of 10 m (negative electrode current collector) and dried. The coating films of the negative electrode mixture were rolled with rollers. The resulting laminate of the negative electrode current collector and the negative electrode material mixture was cut into a predetermined electrode size to produce a negative electrode precursor having a negative electrode material mixture layer on each surface of the negative electrode current collector.

### (3) Preparation of Electrolyte

A nonaqueous solvent was prepared by adding 1 part by mass of vinylene carbonate to 100 parts by mass of a mixture containing EC and EMC at a mass ratio of 1:3. LiPF₆ was dissolved in the nonaqueous solvent at a concentration of 1.0 mol/L to prepare a nonaqueous electrolyte.

### (4) Production of Battery

A positive electrode lead composed of Al was attached to the positive electrode produced above. A negative electrode lead composed of Ni was attached to the negative electrode produced above. The positive electrode and the negative electrode were spirally wound with a 0.015-mm-thick separator containing PP and PE provided therebetween, thereby producing a wound electrode group.

The resulting wound electrode group was inserted into a battery case that was formed of a nickel-plated iron plate and that had a bottomed cylindrical shape having an opening portion. The other end portion of the negative electrode lead was connected to the inner wall of the battery case. The other end portion of the positive electrode lead was connected to the undersurface of a sealing plate. A ring-shaped insulating gasket was attached to the peripheral edge portion of the sealing plate. A predetermined amount of the nonaqueous electrolyte was injected into the battery case. The nickel-plated iron sealing plate was placed on the opening portion of the battery case. Sealing was performed by crimping the opening end portion of the battery case onto the peripheral edge portion of the sealing plate with a gasket provided therebetween. In this way, a nonaqueous electrolyte secondary battery A1 (diameter: 18 mm, and height: 65 mm) was obtained.

### [Evaluation 1: Measurement of Electrode Resistance]

The produced positive electrode was punched into two 2 cm×2 cm squares. A pressure of 2 MPa was applied to the squares that were in a state of facing each other. The resistance between cores of the two electrode plates was defined as electrode resistance.

### [Evaluation 2: Measurement of Discharge Capacity]

The discharge capacity was measured as follows: Charging was performed at a constant current of 0.02 C until the closed circuit voltage of the battery reached 4.2 V, and then discharging was performed at a constant current of 0.02 C until the closed circuit voltage of the battery reached 2.5 V. The charging and discharging were performed in an environment of 25° C.

### [Evaluation 3: Measurement of Heat Release Rate]

Charging was performed at a constant current of 0.02 C until the closed circuit voltage of the battery reached 4.2 V, and then the nonaqueous electrolyte secondary battery was pierced with a nail having a diameter of 0.9 mm at a speed of 1 mm/s and thus forcibly short-circuited. The heat release rate [W] was calculated from the rate of temperature increase of the battery.

### Comparative Example 1

A positive electrode was produced in the same method as in Example 1, except that the step of forming the lithium-ion permeable first film on the surface of the positive electrode precursor was not performed. A nonaqueous electrolyte secondary battery B1 including the resulting positive electrode was produced and evaluated in the same manner as in Example 1.

### Comparative Example 2

As with Example 1, the positive electrode active material was mixed with acetylene black (AB), and poly(vinylidene fluoride) (PVdF). An appropriate amount of N-methyl-2-pyrrolidone (NMP) was added thereto. The mixture was stirred to prepare a positive electrode slurry. In this case, 5 parts by mass of Li₃PO₄ per 100 parts by mass of the positive electrode active material was added to the mixture, thereby preparing the positive electrode slurry. The resulting positive electrode slurry was applied to both surfaces of aluminum foil (positive electrode current collector) and dried. The coating films of the positive electrode material mixture were rolled with rollers to produce a positive electrode. A nonaqueous electrolyte secondary battery B2 including the resulting positive electrode was produced and evaluated in the same manner as in Example 1.

Table 1 presents the evaluation results of Example 1 and Comparative examples 1 and 2. In Table 1, the discharge capacity and the electrode resistance are indicated by relative values when the results of the nonaqueous secondary battery B1 of Comparative example 1 are 100.

TABLE 1

| | Discharge | Electrode | Heat release |
|---|---|---|---|
| Cell | capacity | resistance | rate [W] |
| Al | 100 | 262 | 48 |
| Bl | 100 | 100 | 56 |
| B2 | 95 | 135 | 53 |

As described in Table 1, in the nonaqueous electrolyte secondary battery A1 of Example 1, because the positive electrode active material layer and the positive electrode current collector are covered with the first film, the heat release rate at the time of the short circuit is markedly reduced without decreasing the capacity, compared with the nonaqueous electrolyte secondary batteries B1 and B2 of Comparative examples 1 and 2.

In the nonaqueous electrolyte secondary battery A1 of Example 1, the first films act as resistance, thus increasing the electrode resistance at the time of the short circuit. The increase in electrode resistance reduces the current flowing through the cell. This seems to have reduced the heat release rate at the time of the short circuit in the nonaqueous electrolyte secondary battery A1. Additionally, the proportion (mass ratio) of the first films included in the nonaqueous electrolyte secondary battery A1 is sufficiently low with respect to the positive electrode active material layers. This seems to permit the nonaqueous electrolyte secondary battery A1 to have been able to maintain the same capacity as the nonaqueous electrolyte secondary battery B1 that had no first film.

The nonaqueous electrolyte secondary battery B2 has the positive electrode active material layers formed with the positive electrode slurry containing Li₃PO₄. The nonaqueous electrolyte secondary battery B2 also has a high electrode resistance and a low heat release rate, compared with the nonaqueous electrolyte secondary battery BI. The nonaqueous electrolyte secondary battery B2, however, has a low capacity, compared with the nonaqueous electrolyte secondary batteries A1 and B1. Unlike the nonaqueous electrolyte secondary battery A1, the nonaqueous electrolyte secondary battery B2 was unable to achieve both effects: the maintenance of the battery capacity and the battery safety. Accordingly, the battery safety can be enhanced while maintaining desired battery characteristics by covering the surfaces of the positive electrode active material layers and so forth with the first films.

### INDUSTRIAL APPLICABILITY

The positive electrode according to the present invention is useful as a positive electrode of a secondary battery used for a driving power source for use in a personal computer, a cellular phone, a mobile device, a personal digital assistance (PDA), a portable game device, a video camera, or the like; a main power source or an auxiliary power source for driving an electric motor of a hybrid electric vehicle, a fuel cell vehicle, a plug-in HEV, or the like; or a driving power source for use in an electric power tool, a vacuum cleaner, a robot, or the like.

### REFERENCE SIGNS LIST

1 secondary battery
10 wound electrode group
11 prismatic battery case
12 sealing plate
13 negative electrode terminal
14 positive electrode lead
15 negative electrode lead
16 gasket
17 sealing plug
17a inlet
18 frame body

1. A positive electrode for a secondary battery, comprising:
a positive electrode current collector, a positive electrode active material layer disposed on a surface of the positive electrode current collector, and a first film having lithium-ion permeability,
wherein the first film contains a lithium-ion permeable oxide X represented by LiₓM¹O_{y} (0.5≤x<4, 1≤y<6) and a fluorine-containing compound Y, covers at least part of a surface of the positive electrode active material layer, and partially covers the surface of the positive electrode current collector,
the compound Y contains a bond between a metal element M² and a fluorine element,
M¹ is at least one selected from the group consisting of B, Al, Si, P, S, Ti, V, Zr, Nb, Ta, and La, and M² is at least one selected from the group consisting of Li, Na, Al, Mg, and Ca.

2. The positive electrode for a secondary battery according to claim 1, wherein the oxide X is at least one selected from LiₓPO_{y} (1≤x<3, 3≤y<4) and LiₓSiO_{y} (2≤x<4, 3≤y<4).

3. The positive electrode for a secondary battery according to claim 1, wherein the compound Y contains LiF.

4. The positive electrode for a secondary battery according to claim 1, wherein the positive electrode active material layer contains LiₐNi_{b}M³_{1-b}O₂ (0<a≤1.2, 0.85≤b≤1), and
M³ is at least one selected from the group consisting of Mn, Co, and Al.

5. The positive electrode for a secondary battery according to claim 1, wherein the first film contains nitrogen.

6. The positive electrode for a secondary battery according to claim 1, wherein the positive electrode active material layer contains positive electrode active material particles and a binder, and
the first film partially covers a surface of the binder.

7. The positive electrode for a secondary battery according to claim 6, wherein the positive electrode comprises a region where the first film is not present at an adhesion interface between the positive electrode active material particles and the binder.

8. The positive electrode for a secondary battery according to claim 6, wherein the positive electrode comprises a region where the first film is not present at a contact interface between the positive electrode active material particles and the positive electrode current collector or a contact interface between the positive electrode active material particles adjacent to each other.

9. A secondary battery, comprising the positive electrode for a secondary battery according to claim 1, a negative electrode, and a lithium ion-conducting electrolyte.

10. The secondary battery according to claim 9, wherein the negative electrode includes a negative electrode current collector, a negative electrode active material layer disposed on a surface of the negative electrode current collector, and a second film having lithium-ion permeability, and
the second film contains the oxide X, covers at least part of a surface of the negative electrode active material layer, and partially covers the surface of the negative electrode current collector.

11. A method for producing a positive electrode for a secondary battery, comprising the steps of: providing a positive electrode precursor including a positive electrode current collector and a positive electrode active material layer disposed on a surface of the positive electrode current collector; and
covering at least part of a surface of the positive electrode active material layer with a first film having lithium-ion permeability and partially covering a surface of the positive electrode current collector,
wherein the first film is formed by exposing the positive electrode precursor to an atmosphere containing a raw material of the first film.

12. The method for producing a positive electrode for a secondary battery according to claim 11, wherein the first film is formed by an atomic layer deposition method.
